(19) United States
(12) Patent Application Publication
(10) Pub. No.: US 2014/0098227 A1
(43) Pub. Date: Apr. 10, 2014

(54) REMOTE DOORBELL CONTROL SYSTEM AND RELATED SMART DOORBELL DEVICE

(71) Applicants: Hon Hai Precision Industry Co., Ltd., New Taipei (TW); Hong Fu Jin Precision Industry (ShenZhen) Co., Ltd., Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/038,787

(22) Filed: Sep. 27, 2013

(30) Foreign Application Priority Data
Oct. 10, 2012 (CN) 2012103809131

(51) Int. Cl. H04N 7/18; G08C 17/02

(52) U.S. Cl. CPC H04N 7/186; G08C 17/02
USPC 348/143

(57) ABSTRACT

A remote doorbell control system includes a smart doorbell device, a smart gateway, and a control device having a preset communication number. The smart doorbell device communicates with the control device via the smart gateway. The smart doorbell device includes a doorbell signal generating unit and a control circuit. The doorbell signal generating unit generates a doorbell signal when a visitor has arrived. The control circuit receives the doorbell signal and sends the doorbell signal to the control device, when the smart doorbell device is set to a remote answer mode. The control circuit further activates corresponding functions in response to control signals from the control device.

### BACKGROUND

1. Technical Field

The present disclosure relates to smart home technology, and particularly to a smart doorbell device capable of functioning by remote control and a remote doorbell control system using the smart doorbell device.

2. Description of Related Art

Existing doorbells can provide video function to allow user to check who the visitors are, and to carry out dialogue with the visitors, and then the user can identify the visitors, and decide whether to open the door. However, these doorbells are only for use if the user is at home. If the user is out (not at home) the visitors cannot communicate through the doorbell with the user. Further, the outdoor user cannot check if someone is at the door when not at home.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a remote doorbell control system, according to an embodiment.

FIG. 2 is a block diagram of a smart doorbell device applied in the system of FIG. 1.

FIG. 3 is a block diagram of a smart gateway applied in the system of FIG. 1.

FIG. 4 is a schematic diagram of a control interface displayed on a control device applied in the system of FIG. 1.

FIG. 5 is another schematic diagram of the control interface displayed on the control device of FIG. 4.

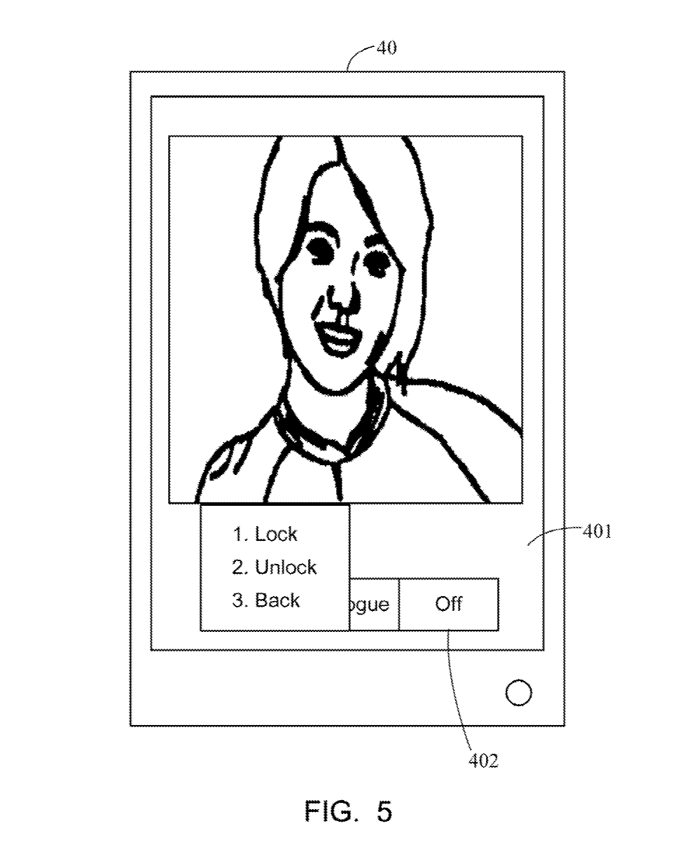

### DETAILED DESCRIPTION

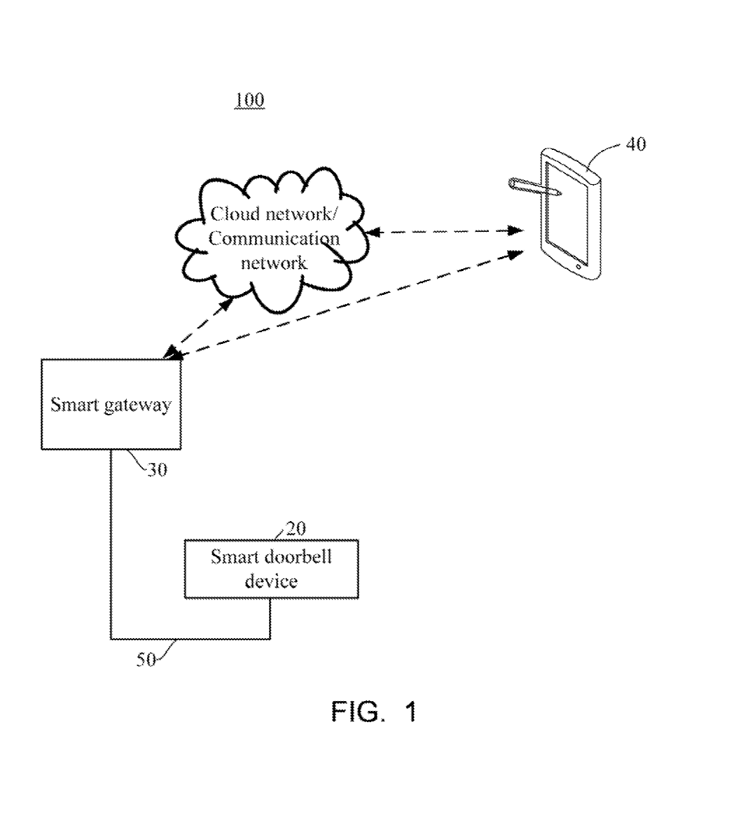

FIG. 1 shows a remote doorbell control system 100 of the embodiment. The system 100 includes a smart doorbell device 20 and a control device 40 having a preset communication number. The smart doorbell device 20 and the control device 40 can communicate with each other. In this embodiment, the system 100 further includes a smart gateway 30. The smart gateway 30 and the control device 40 are respectively connected to cloud network or communication network, and the control device 40 can communicate with the smart gateway 30 via wired or wireless communication technologies.

In this embodiment, the smart doorbell device 20 generates doorbell signal and sends it to the control device 40 via the smart gateway 30, and user can use the control device 40 to send control signals to the smart doorbell device 20 via the smart gateway 30. The smart doorbell device 20 executes corresponding functions when it receives the control signals. The smart doorbell device 20 can further send doorbell information back to the control device 40 for user to check, via or not via the smart gateway 30. Therefore, the user can remote control the smart doorbell device 20 via the control device 40.

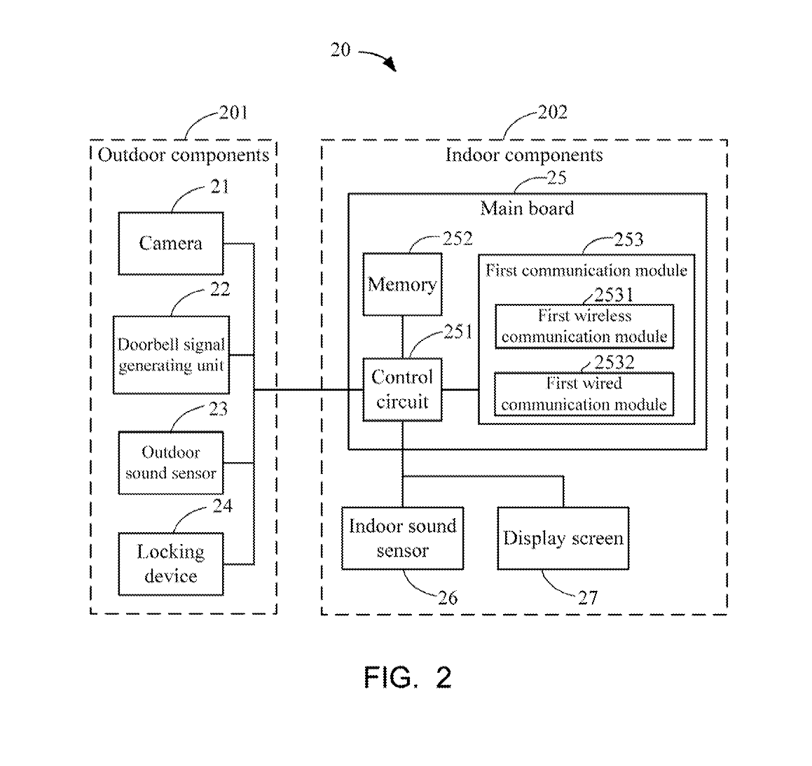

FIG. 2 shows that the smart doorbell device 20 includes outdoor components 201 and indoor components 202. The outdoor components 201 include a camera 21, a doorbell signal generating unit 22, an outdoor sound sensor 23 and a locking device 24. The indoor components 202 include a main board 25, an indoor sound sensor 26 and a display screen 27. The main board 25 is provided with a control circuit 251, a memory 252, and a first communication module 253.

The doorbell signal generating unit 22 generates a doorbell signal and sends the doorbell signal to the control circuit 251. In an embodiment, the doorbell signal generating unit 22 comprises a button for activating the generation of the doorbell signal when it is pressed. In another embodiment, the doorbell signal generating unit 22 comprises a proximity sensor for activating the generation of the doorbell signal when it has sensed that someone come close to it.

The camera 21 captures video of outdoor surroundings.

The outdoor sound sensor 23 and the indoor sound sensor 26 respectively sense outdoor and indoor sound signals, and obtain corresponding audio information.

The display screen 27 displays the video captured by the camera 21, and provides an operation interface for the user to answer the doorbell signal, or enable or unable a dialogue function, et al.

The memory 252 stores answer modes for the smart doorbell device 20. In this embodiment, the answer modes for the smart doorbell device 20 include a local answer mode and a remote answer mode. In a first embodiment, the answer modes for the smart doorbell device 20 are switchable by the user through the operation interface provided on the display screen 27. In a second embodiment, when the control circuit 251 receives the doorbell signal, the control circuit 251 automatically sets the local answer mode. If the control circuit 251 does not receive any response signal, such as an unlocking control signal to unlock the door, in a predetermined time period, the control circuit 251 determines that nobody is at home at this time, and then automatically switches the local answer mode to the remote answer mode for the smart doorbell device 20. In a third embodiment, the system 100 further includes an indoor sensor for sensing whether someone is at home. When the indoor sensor obtains sensed information indicating that someone is home at this time, the control circuit 251 automatically sets the smart doorbell device 20 to the local answer mode; otherwise, the control circuit 251 automatically sets the smart doorbell device 20 to the remote answer mode.

In this embodiment, if the smart doorbell device is set to the local answer mode, when the control circuit 251 receives a doorbell signal. The control circuit 251 controls the indoor sound sensor 26 to ring to alert indoor user that a visitor has arrived. Simultaneously the control circuit 251 controls the camera 21 to capture video of outdoor surroundings, controls the display screen 27 to display the video, and activates the outdoor sound sensor 23 and the indoor sound sensor 26 to carry out a dialogue between the indoor user and the visitor.

If the smart doorbell device is set to the remote answer mode, when the control circuit 251 receives a doorbell signal. The control circuit 251 sends the doorbell signal to the control device 40 having the preset communication number via the smart gateway 30.

In this embodiment, the first communication module 253 includes a first wireless communication module 2531 and a first wired communication module 2532.

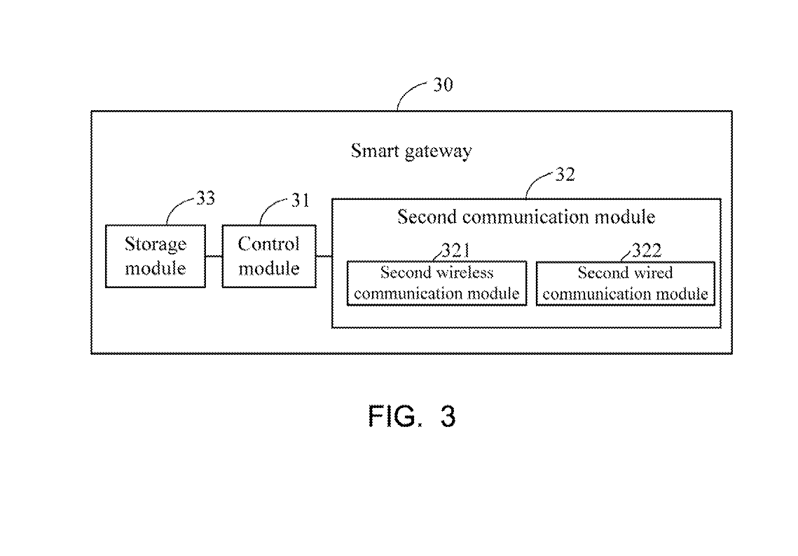

FIG. 3 shows that the smart gateway 30 includes a control module 31, a second communication module 32, and a storage module 33. The storage module 23 stores the preset communication number. The second communication module 32 can communicate with the first communication module 253 of the smart doorbell device 20.

The second communication module 32 includes a second wireless communication module 321 and a second wired communication module 322.

In this embodiment, the first wireless communication module 2531 and the second wireless communication module 321 can both emit and receive near field wireless signals, in order to allow the smart doorbell device 20 to communicate with the smart gateway 30 via wireless communication technology. The near field wireless signals may include, but are not limited to be, infrared, BLUETOOTH, Z-WAVE, NFC, ZIGBEE, RF, and WIFI signals.

The first wired communication module 2532 and the second wired communication module 322 can communicate with each other via Power Line Communication (PLC), Optical Fiber Power Line Communication (OPLC), or via the Internet, coaxial cable, telephone line, or other communication technologies. Therefore, the smart doorbell device 20 can communicate with the smart gateway 30 via wired communication technology.

In this embodiment, the smart doorbell device 20 is connected to the smart gateway 30 via a power line 50 (as shown in FIG. 1), and the first wired communication module 2532 and the second wired communication module 322 communicate with each other via PLC or OPLC technologies. Each of the first wired communication module 2532 and the second wired communication module 322 can gather data from or transmit data into the power lines 50. Therefore, the power line 50 not only supplies power to the devices, but also serves as data carrier.

The second wireless communication module 321 of the smart gateway 30 can also communicate with the control device 40 via near field wireless communication technology. Correspondingly, the control device 40 may be selected from a group consisting of a mobile phone, a tablet computer, and a notebook computer, which is provided with infrared, BLUETOOTH, Z-WAVE, ZIGBEE, RF, or WIFI communication functions.

In this embodiment, the second communication module 32 of the smart gateway 30 can also communicate with the control device 40 via Internet, GPRS, GSM, CDMA, 3G, or 4G communication technologies. Correspondingly, the control device 40 may be a computer, which can be connected to Internet, or may be a mobile phone, which is provided with GPRS, GSM, CDMA, 3G, or 4G communication functions.

In this embodiment, the control circuit 251 controls the first communication module 253 to send the doorbell signal to the smart gateway 30. The second communication module 32 of the smart gateway 30 receives the doorbell signal, and the control module 31 reads the preset communication number from the storage module 33 in response to the doorbell signal, and controls the second communication module 32 to sends the doorbell signal to the control device 40 having the preset communication number.

The second communication module 32 of the smart gateway 30 can also receive control signals from the control device 40 and send the control signals to the smart doorbell device 20. The control circuit 251 of the smart doorbell device 20 then activates corresponding functions in response to the control signals. Therefore, the system 100 allows the user to operate the control device 40 in his hands to remotely control the smart doorbell device 20 at anywhere and anytime.

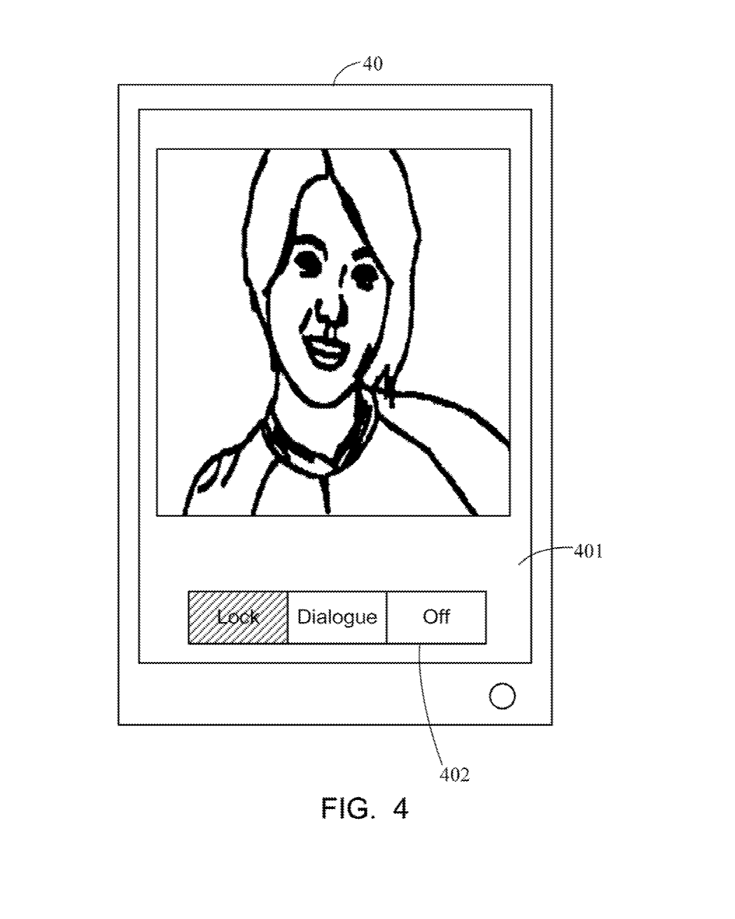

FIG. 4 shows that the control device 40 can provide a control interface 401 for the user responding to the doorbell signal, when it receives the doorbell signal. The control device 40 can also generate the control signals in response to the user's input in the control interface 401, and sends the control signals back to the smart doorbell device 20 via the smart gateway 30.

In this embodiment, the control signals include, but are not limited to be, video control signal, audio control signal, and unlocking control signal.

In this embodiment, the control device 40 can first pop-up a hint to alert the user whether to check the video, and generates a video control signal back to the smart doorbell device 20 if the user chooses to check the video.

The control device 40 can then display the control interface 401. The control interface 401 can be provided with a display area for displaying the video, and several control icons 402, such as “Lock” icon, “Dialogue” icon, “Off” icon, which aligns with the display area.

The control circuit 251 activates the camera 21 to real timely capture the video and controls the first communication module 253 to send the video to the control device 40 for displaying, in response to the video control signal.

If the user further chooses the “Dialogue” icon, the control device 40 generates an audio control signal and sends it to the smart doorbell device 20. The control circuit 251 of the smart doorbell device 20 activates the outdoor sound sensor 23 in response to the audio control signal. Then the audio information can be transmitted between the smart doorbell device 20 and the control device 40 in real time.

If the user further chooses an “Unlock” option associated to the “Lock” icon, the control device 40 generates an unlocking control signal and sends it to the smart doorbell device 20. The control circuit 251 of the doorbell device 20 controls the locking device 24 to open the door in response to the unlocking control signal.

In another embodiment, even if no doorbell signal has been received, the user can use the control device 40 to actively send control signals to the smart doorbell device 20 to check doorbell information of the house. Therefore, the security of the house can be improved.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A remote doorbell control system comprising:
a control device having a preset communication number; and
a smart doorbell device comprising:
a first communication module configured to communicate with the control device;
a doorbell signal generating unit configured to generate a doorbell signal; and
a control circuit configured to receive the doorbell signal and control the first communication module to send the doorbell signal to the control device, when the smart doorbell device is set to a remote answer mode; the control circuit further configured to activate corresponding functions in response to control signals from the control device.

2. The system as described in claim 1, wherein the smart doorbell device further comprises a camera for capturing video of outdoor surroundings, wherein the control circuit controls the first communication module to send the video to the control device for displaying in response to a video control signal from the control device.

3. The system as described in claim 2, wherein the smart doorbell device further comprises a display screen configured to display the video and provide an operation interface for answering the doorbell signal and enabling a dialogue function.

4. The system as described in claim 1, wherein the smart doorbell device further comprises an outdoor sound sensor configured to sense outdoor sound signal, and obtain outdoor audio information; wherein the control circuit activates the outdoor sound sensor in response to an audio control signal from the control device, in order to allow the audio information to be transmitted between the smart doorbell device and the control device in real time.

5. The system as described in claim 1, wherein the smart doorbell device further comprises a locking device configured to open a door in response to an unlocking control signal from the control device.

6. The system as described in claim 1, wherein the control device provides a control interface for responding to the doorbell signal, when it receives the doorbell signal, and generates the control signals in response to a user's input in the control interface.

7. The system as described in claim 1, wherein the smart doorbell device further comprises a memory configured to store answer modes for the smart doorbell device, wherein the answer modes comprises a local answer mode and the remote answer mode.

8. The system as described in claim 7, wherein the answer modes for the smart doorbell device are switchable by a user.

9. The system as described in claim 7, wherein when the control circuit receives the doorbell signal, but does not receive any response signal in a predetermined time period, the control circuit automatically sets the smart doorbell device to the remote answer mode.

10. The system as described in claim 1, further comprising a smart gateway, wherein the smart doorbell device communicates with the control device via the smart gateway, the smart gateway comprises:
a storage module configured to store the preset communication number;
a second communication module configured to receive the doorbell signal from the first communication module of the smart doorbell device, and receive the control signals from the control device; and
a control module configured to read the preset communication number from the storage module, and control the second communication module to send the doorbell signal to the control device having the preset communication number, when the second communication module receives the doorbell signal; the control module further configured to control the second communication module to send the control signals to the smart doorbell device.

11. The system as described in claim 10, wherein the first communication module comprises a first wireless communication module, the second communication module comprises a second wireless communication module, the first wireless communication module and the second wireless communication module are both configured to emit and receive near field wireless signals, in order to allow the smart doorbell device to communicate with the smart gateway via wireless communication technology; wherein the near field wireless signal is selected from a group consisting of infrared, BLUETOOTH, Z-WAVE, NFC, ZIGBEE, RF, and WIFI signals.

12. The system as described in claim 10, wherein the smart doorbell device is connected to the smart gateway via a power line, the first communication module comprises a first wired communication module, the second communication module comprises a second wired communication module, and the first wired communication module and the second wired communication module communicate with each other via PLC or OPLC technologies, in order to allow the smart doorbell device to communicate with the smart gateway via wired communication technology.

13. A smart doorbell device comprising:
a communication module;
a doorbell signal generating unit configured to generate a doorbell signal; and
a control circuit configured to receive the doorbell signal and control the communication module to send the doorbell signal to a control device having a preset communication number, when the smart doorbell device is set to a remote answer mode; the control circuit further configured to activate corresponding functions in response to control signals from the control device.

14. The smart doorbell device as described in claim 13, wherein the smart doorbell device further comprises a camera for capturing video of outdoor surroundings, wherein the control circuit controls the first communication module to send the video to the control device for displaying in response to a video control signal from the control device.

15. The smart doorbell device as described in claim 14, wherein the smart doorbell device further comprises a display screen configured to display the video and provide an operation interface for answering the doorbell signal and enabling a dialogue function.

16. The smart doorbell device as described in claim 13, wherein the smart doorbell device further comprises an outdoor sound sensor configured to sense outdoor sound signal, and obtain outdoor audio information; wherein the control circuit activates the outdoor sound sensor in response to an audio control signal from the control device, in order to allow the audio information to be transmitted between the smart doorbell device and the control device in real time.

17. The smart doorbell device as described in claim 13, wherein the smart doorbell device further comprises a locking device configured to open a door in response to an unlocking control signal from the control device.

18. The smart doorbell device as described in claim 13, wherein the smart doorbell device further comprises a memory configured to store answer modes for the smart doorbell device, wherein the answer modes comprises a local answer mode and the remote answer mode.

19. The smart doorbell device as described in claim 18, wherein the answer modes for the smart doorbell device are switchable by a user.

20. The smart doorbell device as described in claim 18, wherein when the control circuit receives the doorbell signal, but does not receive any response signal in a predetermined time period, the control circuit automatically sets the smart doorbell device to the remote answer mode.
